(19) United States
(12) Patent Application Publication
(10) Pub. No.: US 2026/0162858 A1
(43) Pub. Date: Jun. 11, 2026

(54) COLUMNAR RESISTOR AND METHOD OF LASER TRIMMING FOR MANUFACTURING THE SAME

(71) Applicant: VIKING TECH CORPORATION, Hsinchu County (TW)

(72) Inventors: Chi-Lun LI, Hsinchu County (TW); CHI-YU LU, Hsinchu County (TW)

(21) Appl. No.: 19/416,273

(22) Filed: Dec. 11, 2025

(30) Foreign Application Priority Data
Dec. 11, 2024 (TW) 113148191

(51) Int. Cl. H01C 17/242

(52) U.S. Cl. CPC H01C 17/242

(57) ABSTRACT

A columnar resistor and a method of laser trimming for manufacturing the same are provided. The columnar resistor includes a resistance layer disposed on the surface of a columnar substrate and the resistive layer includes a resistance determining area, a first resistance adjustment area, and a second resistance adjustment area. The resistance determining area is configured to form a first laser-trimming line and achieve a first resistance value by a first laser-trimming. The first resistance adjustment area is configured to form a second laser-trimming line and achieve a second resistance value by a second laser-trimming. The resistance value is precisely adjusted by two laser-trimming processes of the resistive layer, thereby improving the stability of product manufacturing.

### CROSS-REFERENCE TO RELATED APPLICATIONS

This application claims priority to Taiwan Patent Application No. 113148191, filed on Dec. 11, 2025, and entitled “COLUMNAR RESISTOR AND METHOD OF LASER TRIMMING FOR MANUFACTURING THE SAME”, the entirety of which is incorporated herein by reference.

### BACKGROUND OF THE INVENTION

### 1. Field of the Invention

The present disclosure relates to the technical field of columnar resistors, and more particularly to a columnar resistor and a method of laser trimming for manufacturing the same.

### 2. Description of the Prior Art

Traditional methods for manufacturing columnar resistors involve sputtering a thin film resistive layer on the surface of a substrate, followed sequentially by processes such as capping or plating to form end electrodes, trimming, and coating. During the manufacturing process, there are many procedures that lead to the aging of the various elements of the columnar resistor, causing a deviation in the resistance value and inconsistent quality. Therefore, it is difficult to manufacture columnar resistors with a low resistance tolerance of the resistance value.

Furthermore, as current electronic products trend toward miniaturization, the size of columnar resistors must be reduced in overall volume while enhancing product performance. Therefore, it is practically difficult to perform a rework operation on columnar resistors that do not meet specifications, which results in low product yield and stability.

### SUMMARY OF THE INVENTION

In view of the foregoing, the present disclosure provides a method of laser trimming for manufacturing a columnar resistor, including:
forming a resistance layer on a surface of a columnar substrate, wherein the resistance layer includes a resistance determining region, a first resistance adjustment region, and a second resistance adjustment region;
forming a metal layer at both ends of the columnar substrate, and the metal layer being connected to the resistance layer to form two electrodes;
performing a first laser-trimming on the resistance determining region to form a first trimming line and achieve a first resistance value; and
performing a second laser-trimming on the first resistance adjustment region to form a second trimming line and achieve a second resistance value, wherein the second resistance value is greater than 0.1% to 1% of the first resistance value.

Preferably, a surface area of the resistance determining region is respectively greater than a surface area of the first resistance adjustment region and a surface area of the second resistance adjustment region.

Preferably, a surface area ratio of the resistance determining region, the first resistance adjustment region, and the second resistance adjustment region is 50-70:15-25:15-25.

Preferably, an interval distance between the first trimming line and the second trimming line is equal to or greater than an interval distance between the adjacent first trimming lines.

Furthermore, the present disclosure further provides a columnar resistor, including:
a columnar substrate;
a resistance layer disposed on a surface of the columnar substrate, wherein the resistance layer includes a resistance determining region, a first resistance adjustment region, and a second resistance adjustment region; and
a metal layer disposed at both ends of the columnar substrate, wherein the metal layer is connected to the resistance layer to form two electrodes;
wherein the resistance determining region is configured to form a first trimming line and achieve a first resistance value by a first laser-trimming, the first resistance adjustment region is configured to form a second trimming line and achieve a second resistance value by a second laser-trimming, and the second resistance value is greater than 0.1% to 1% of the first resistance value.

Preferably, a surface area of the resistance determining region is greater than a surface area of the first resistance adjustment region and a surface area of the second resistance adjustment region.

Preferably, a surface area ratio of the resistance determining region, the first resistance adjustment region, and the second resistance adjustment region is 50-70:15-25:15-25.

Preferably, an interval distance between the first trimming line and the second trimming line is equal to or greater than an interval distance between the adjacent first trimming lines.

Preferably, the columnar resistor component has a standard deviation of the resistance value of 0.030 or less and/or a resistance tolerance of 0.03% or less.

The columnar resistor of the present disclosure utilizes a multi-stage laser-trimming by providing the resistance determining region, the first resistance adjustment region, and the second resistance adjustment region. By controlling the different surface areas, trimming line intervals, trimming line widths, and electric current paths after trimming for the resistance determining region, the first resistance adjustment region, and the second resistance adjustment region, these areas possess different resistance values and connected in series, thereby precisely controlling the resistance value of the columnar resistor, solving the technical problems of inconsistent quality due to component aging during manufacturing and the difficulty in fine-tuning the resistance value of miniaturized columnar resistors. The present disclosure also overcomes the manufacturing bottleneck of high standard deviation and resistance tolerance in the resistance values of conventional columnar resistors, which is beneficial for manufacturing high-precision and high-stability columnar resistors.

### BRIEF DESCRIPTION OF THE DRAWINGS

FIG. 1 is a schematic view of a first embodiment of the columnar resistor 1 of the present disclosure.

FIG. 2 is a schematic view of a second embodiment of the columnar resistor 1 of the present disclosure.

FIG. 3 is a flowchart of the method of laser trimming for manufacturing the columnar resistor 1 of the present disclosure.

FIG. 4 is a comparative diagram of the standard deviation of the resistance value for different embodiments of the columnar resistor manufactured by the method of laser trimming for manufacturing the columnar resistor of the present disclosure.

FIG. 5 is a comparative diagram of the resistance tolerance of the resistance value for different embodiments of the columnar resistor manufactured by the method of laser trimming for manufacturing the columnar resistor of the present disclosure.

### DESCRIPTION OF THE PREFERRED EMBODIMENTS

The following embodiments, in conjunction with the drawings, are intended to illustrate the spirit of the present disclosure, enabling those skilled in the art to clearly understand the technology of the present disclosure, but are not intended to limit the scope of the present disclosure. The scope of patent rights of the present disclosure should be defined by the claims. It is particularly emphasized that the drawings are for illustrative purposes only and do not represent the actual size or quantity of the elements, and some details may not be completely drawn to ensure the conciseness of the drawings.

For the sake of conciseness in the description, a cylindrical resistor is taken as an example, but it should be understood that this is for illustration and not for limiting the present disclosure; the columnar resistor 1 of the present disclosure can be implemented in any shape.

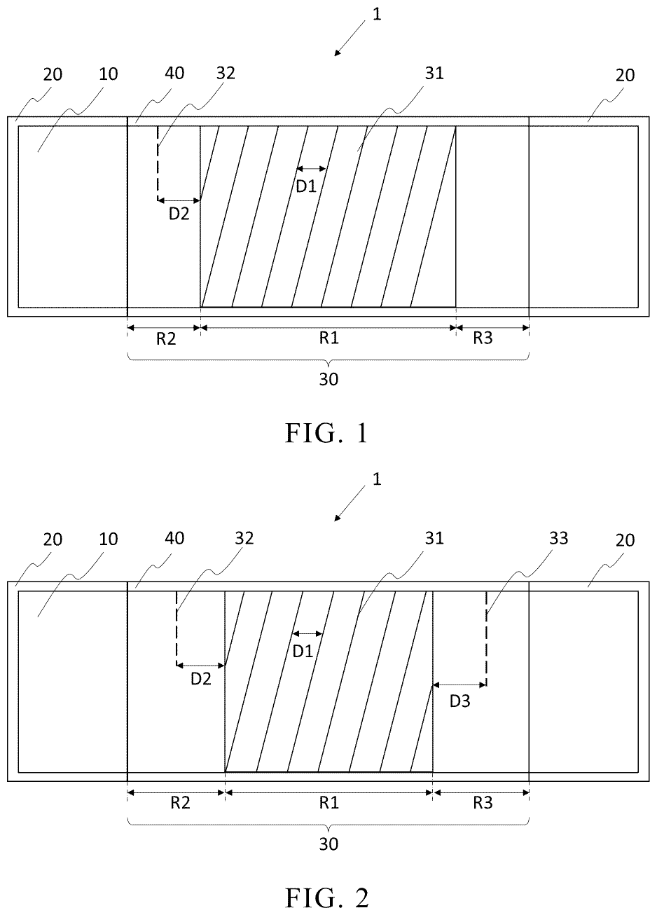

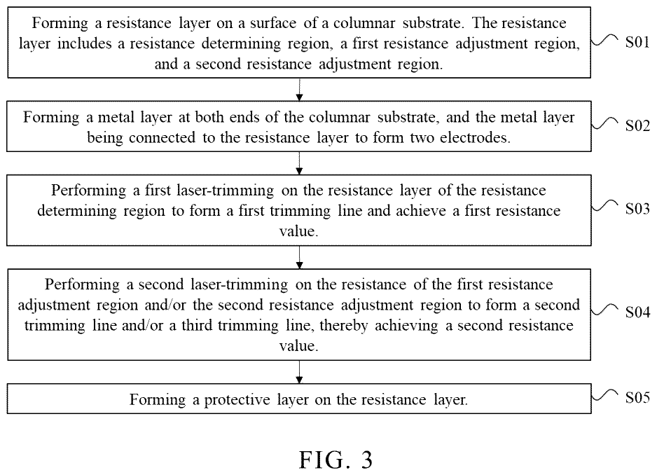

Please refer to FIGS. 1 to 3. FIG. 1 is a schematic view of a first embodiment of the columnar resistor of the present disclosure. FIG. 2 is a schematic view of a second embodiment of the columnar resistor of the present disclosure. FIG. 3 is a flowchart of the method of laser trimming of the present disclosure.

The columnar resistor 1 of the present disclosure is provided with a columnar substrate 10, an electrode layer 20, a resistance layer 30, and a protective layer 40.

The method of laser trimming for manufacturing the high-precision columnar resistor 1 of the present disclosure is as follows:

Step S01: Forming a resistance layer 30 on a surface of a columnar substrate 10. The resistance layer 30 includes a resistance determining region R1, a first resistance adjustment region R2, and a second resistance adjustment region R3. The resistance determining region R1 abuts against to the first resistance adjustment region R2 and the second resistance adjustment region R3. The resistance layer 30 covers the surface of the columnar substrate 10 by printing or sputtering. The surface area of the resistance determining region R1 greater than the surface area of the first resistance adjustment region R2 and the surface area of the second resistance adjustment region R3. The surface area of the first resistance adjustment region R2 may be equal to the surface area of the second resistance adjustment region R3. The surface area ratio of the resistance determining region R1, the first resistance adjustment region R2, and the second resistance adjustment region R3 is 50-70:15-25:15-25.

The material of the columnar substrate 10 may be alumina. The material of the resistance layer 30 may be nickel chromium (NiCr), nickel chromium silicon (NiCrSi), chromium silicon (CrSi), tantalum nitride-based compounds, or a combination thereof.

Step S02: Forming a metal layer at both ends of the columnar substrate 10, and the metal layer being connected to the resistance layer 30 to form two electrodes 20. The metal layer covers the metal layer by side dipping, sputtering, or electroplating to form metal cap-like electrodes 20. One electrode abuts against the first resistance adjustment region R2, and the other electrode abuts against the second resistance adjustment region R3.

The material of the electrode layer 20 can be nickel-tin plating, nickel plating, nickel-phosphorus plating, or copper-nickel-tin plating.

Step S03: Performing a first laser-trimming on the resistance layer 30 of the resistance determining region R1 to form a first trimming line 31 and achieve a first resistance value. The first trimming line 31 is formed by a helical cut (spiral cut) around the resistance determining region R1, and the number of turns for the first trimming line 31 is less than 9 turns, preferably 3 to 9 turns. The first interval distance D1 between each turn of the first trimming line 31 is 20 to 35 μm.

Step S04: Performing a second laser-trimming on the resistance of the first resistance adjustment region R2 and/or the second resistance adjustment region R3 to form a second trimming line 32 and/or a third trimming line 33, thereby achieving a second resistance value. The second resistance value is 0.1% to 1% greater than the first resistance value. The second trimming line 32 and/or the third trimming line 33 are formed by a straight or curved cut in the first resistance adjustment region R2 and/or the second resistance adjustment region R3. In other words, the second trimming line 32 and/or the third trimming line 33 do not circle the first resistance adjustment region R2 and/or the second resistance adjustment region R3. Specifically, the number of turns for the second trimming line 32 and/or the third trimming line 33 is less than 1 turn, preferably 0.5 to 1 turn. Therefore, the turn ratio of the first trimming line 31 to the second trimming line 32 is 3-9:0.5-1, and/or the turn ratio of the first trimming line 31, the second trimming line 32, and the third trimming line 33 is 3-9:0.5-1:0.5-1.

The first trimming line 31 and the second trimming line 32 can be dashed or solid lines, respectively. The line width of the first trimming line 31 and the second trimming line 32 is 25 to 35 μm. The second interval distance D2 between the first trimming line 31 and the second trimming line 32 is 25 to 35 μm. The third interval distance D3 between the first trimming line 31 and the third trimming line 33 is 25 to 35 μm. The second interval distance D2 or the third interval distance D3 is equal to or greater than the first interval distance D1 between the adjacent turns of the first trimming line.

Step S05: Forming a protective layer 40 on the resistance layer 30. The material of the protective layer 40 is epoxy resin or a mixture of epoxy resin. The protective layer 40 covers the resistance layer 30 by a roll coating process.

The processes used in the present disclosure, such as printing, sputtering, side dipping, electroplating, laser processing, and roll coating, can be performed using conventional techniques to achieve the same effect. For the sake of conciseness in the specification, the present disclosure does not redundantly describe the details herein.

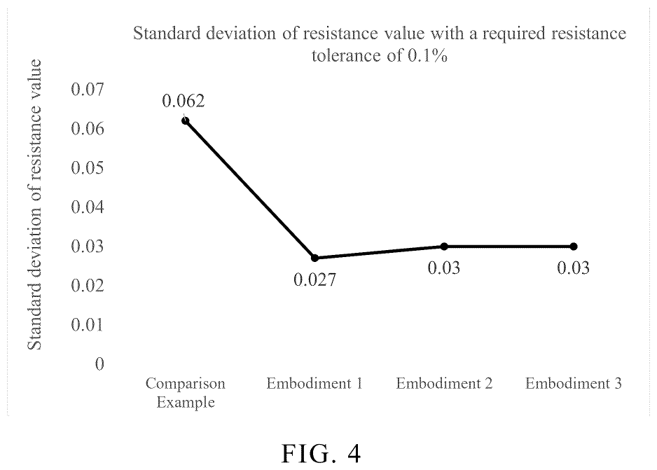

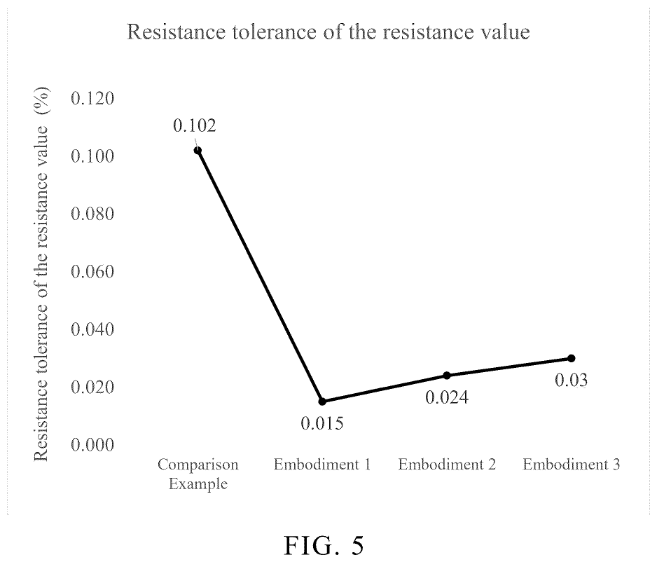

Please refer to FIGS. 4 to 5. FIG. 4 is a comparative diagram of the standard deviation of the resistance value for different embodiments of the high-resistance columnar resistor manufactured by the method of laser trimming of the present disclosure. FIG. 5 is a comparative diagram of the resistance tolerance of the resistance value for different embodiments of the columnar resistor manufactured by the method of laser trimming of the present disclosure. The columnar resistors used in FIGS. 4 and 5 are shown in Table 1. The Comparison Example underwent only a single laser-trimming, while Embodiments 1 to 3 underwent the laser trimming method of the present disclosure, performing a first laser-trimming on the resistance determining region R1, and performing a second laser-trimming on one of the first resistance adjustment region R2 and the second resistance adjustment region R3.

TABLE 1

| | Surface area | Surface area | Surface area |
|---|---|---|---|
| | of the | of the first | of the second |
| | resistance- | resistance | resistance |
| | determining | adjustment | adjustment |
| | region (%) | region (%) | region (%) |
| Comparison | 90 | 0 | 0 |
| Example | | | |
| Embodiment 1 | 70 | 15 | 15 |
| Embodiment 2 | 60 | 20 | 20 |
| Embodiment 3 | 50 | 25 | 25 |

FIG. 4 shows the standard deviation of the resistance values for the columnar resistors manufactured according to Table 1 when the required resistance tolerance of the resistance value is 0.1%. The standard deviation of the resistance value for the Comparison Example is 0.062, while the standard deviation for Embodiments 1 to 3 is 0.027 to 0.030. Results show that the laser trimming method of the present disclosure reduces the standard deviation, which increases the yield of manufacturing high-precision columnar resistors.

FIG. 5 shows the resistance tolerance of the resistance values for the columnar resistors manufactured according to Table 1. The resistance tolerance of the resistance value for the Comparison Example is only 0.102%, while the resistance tolerance for Embodiments 1 to 3 reaches 0.015% to 0.03%. Results show that the laser trimming method of the present disclosure overcomes the manufacturing bottleneck related to the resistance tolerance of columnar resistors, achieving a resistance tolerance as low as 0.015%.

The columnar resistor of the present disclosure utilizes a multi-stage laser-trimming by providing the resistance determining region, the first resistance adjustment region, and the second resistance adjustment region. By controlling the different surface areas, trimming line intervals, trimming line widths, and electric current paths after trimming for the resistance determining region, the first resistance adjustment region, and the second resistance adjustment region, these areas possess different resistance values and connected in series, thereby precisely controlling the resistance value of the columnar resistor, solving the technical problems of inconsistent quality due to component aging during manufacturing and the difficulty in fine-tuning the resistance value of miniaturized columnar resistors. The present disclosure also overcomes the manufacturing bottleneck of high standard deviation and resistance tolerance in the resistance values of conventional columnar resistors, which is beneficial for manufacturing high-precision and high-stability columnar resistors.

What is claimed is:

1. A method of laser trimming for manufacturing a columnar resistor, comprising:
forming a resistance layer on a surface of a columnar substrate, wherein the resistance layer comprises a resistance determining region, a first resistance adjustment region, and a second resistance adjustment region;
forming a metal layer at both ends of the columnar substrate, and the metal layer being connected to the resistance layer to form two electrodes;
performing a first laser-trimming on the resistance determining region to form a first trimming line and achieve a first resistance value; and
performing a second laser-trimming on the first resistance adjustment region to form a second trimming line and achieve a second resistance value, wherein the second resistance value is greater than 0.1% to 1% of the first resistance value;
wherein an interval distance between the first trimming line and the second trimming line is equal to or greater than an interval distance between the adjacent first trimming lines.

2. The method of claim 1, wherein a surface area of the resistance determining region is respectively greater than a surface area of the first resistance adjustment region and a surface area of the second resistance adjustment region.

3. The method of claim 1, wherein a surface area ratio of the resistance determining region, the first resistance adjustment region, and the second resistance adjustment region is 50-70: 15-25:15-25.

4. A columnar resistor, comprising:
a columnar substrate;
a resistance layer disposed on a surface of the columnar substrate, wherein the resistance layer comprises a resistance determining region, a first resistance adjustment region, and a second resistance adjustment region; and
a metal layer disposed at both ends of the columnar substrate, wherein the metal layer is connected to the resistance layer to form two electrodes;
wherein the resistance determining region is configured to form a first trimming line and achieve a first resistance value by a first laser-trimming, the first resistance adjustment region is configured to form a second trimming line and achieve a second resistance value by a second laser-trimming, and the second resistance value is greater than 0.1% to 1% of the first resistance value, an interval distance between the first trimming line and the second trimming line is equal to or greater than an interval distance between the adjacent first trimming lines.

5. The columnar resistor of claim 5, wherein a surface area of the resistance determining region is greater than a surface area of the first resistance adjustment region and a surface area of the second resistance adjustment region.

6. The columnar resistor of claim 5, wherein a surface area ratio of the resistance determining region, the first resistance adjustment region, and the second resistance adjustment region is 50-70:15-25:15-25.
